(19) United States
(12) Patent Application Publication
(10) Pub. No.: US 2020/0068073 A1
(43) Pub. Date: Feb. 27, 2020

(54) SYSTEM AND METHOD FOR MOBILE DATA SHARING

(71) Applicant: TUBE Incorporated, Chelmsford, MA (US)

(72) Inventors: Harjot Singh Saluja, Nashua, MA (US); Julia Hudson Metcalf, Melrose, MA (US); Shantigram Jagannath, Chelmsford, MA (US); Sharmistha Chatterjee, Karnataka (IN)

(73) Assignee: TUBE Incorporated, Chelmsford, MA (US)

(21) Appl. No.: 16/549,505

(22) Filed: Aug. 23, 2019

Related U.S. Application Data
(60) Provisional application No. 62/722,348, filed on Aug. 24, 2018.

(51) Int. Cl. H04M 15/00; H04W 4/24

(52) U.S. Cl. CPC H04M 15/66; H04M 15/09; H04W 4/24

(57) ABSTRACT

According to various embodiments, a social mobile data sharing platform (SMDSP) is disclosed. The SMDSP includes a data sharing onboarding portal (DSOP) configured to onboard one or more social entities for offering mobile connectivity to one or more sponsees. The SMDSP further includes a shared data pool service configured to aggregate mobile data from one or more contributing sponsors. The SMDSP additionally includes an artificial intelligence (AI) server configured to evaluate a volume of mobile data to be granted to the sponsees from the shared data pool service to be offered by the one or more social entities. The evaluation is based on at least one of country of the sponsee, socio-economic background of the sponsee, and serving network operator of the sponsee.

### CROSS-REFERENCE TO RELATED APPLICATIONS

This application claims priority to provisional applications 62/722,348, filed Aug. 24, 2018, which is herein incorporated by reference in its entirety.

### FIELD OF THE INVENTION

The present invention relates generally to mobile data sharing and, more particularly, to a social mobile data sharing platform configured to allow for social entities to support and offer mobile connectivity philanthropically.

### BACKGROUND OF THE INVENTION

Ever since the growth of the number of mobile devices and innumerable mobile connectivity plans offered by network operators, the mobile-app industry has been blooming with different types of apps that play an important role in facilitating daily life in a number of ways. Even though it has become an integral part of everyday life, the frequent usage of mobile connectivity, its services, updates, and/or notifications have been limited to those who can afford to buy connectivity plans. The situation becomes worse in countries with a high cost of mobile connectivity plans where access becomes impossible for lot of people. This has social implications as a large section of people or community may not have access to the interne to read the news, watch educational videos, or call an emergency service when they are in the middle of natural calamity or disaster.

With improvements in cellular network infrastructure, cutting edge technology like 5G, data has also become cheap and affordable in many countries. Cheap attractive connectivity plans have attracted wider audience, but have not been able to devise a strategy to offer mobile connectivity or share mobile data in a meaningful manner with those in need. The data plans being cheap expire over a limited period even when the data limits are left unused in the account. To encourage users who are buyers of mobile connectivity plans to support social causes and charity, there is a need to redesign and evolve the connectivity plans offered by network operators and provide an infrastructure to support, share, transfer, and measure data from one user account to another user account across operators and countries. Further, helping for social causes can create significant impacts when non-governmental organizations (NGOs), large corporations, and/or profitable business operations come forward to get involved and create a supporting ecosystem and provide opportunities for those in need to get digitally connected.

Security, privacy, and authenticity issues are challenging issues of today for building a unified platform to provide mobile connectivity options (prepaid/postpaid) and enable data distribution from individual users, NGOs, or corporate accounts to those in need. The challenges behind creating an infrastructure to connect people with mobile plans can be addressed by offering one or more of the following:

Easy, simple, transparent, and/or selective mobile connectivity plans available to end-users who are sponsors;

multiple free mobile connectivity plans offered to people in need for a social cause;

data distribution to any selected 3^{rd}-party or to end-users by creating an intermediary connectivity and data account from where connectivity/data can be distributed to subscribers under any operator network;

remote communication medium by which sponsees can provide acknowledgement to sponsors;

maintenance of user-privacy, prevent leakage of personal information of user payment accounts during any acts of data distribution;

sharing connectivity plans within community members or anonymous users with/without knowing user-identity;

donation plans to involve large corporates and businesses to contribute matching amount for socially challenging purposes;

identify social improvement metrics, track, address and create plans for improvement;

initiatives to provide mobile interne connectivity to everyone by associating a reward system to users who truly make of use of mobile connectivity;

connecting people in the remotest corner of the world bringing the sponsor and the sponsee under a common platform;

addressing daily life challenges, emergency, and disaster events status reporting by use of mobile connectivity from multiple devices; and

improved alerts and messaging system to alert authorized entities for addressing social issues within a limited period.

### SUMMARY OF THE INVENTION

According to various embodiments, a social mobile data sharing platform (SMDSP) is disclosed. The SMDSP includes a data sharing onboarding portal (DSOP) configured to onboard one or more social entities for offering mobile connectivity to one or more sponsees. The SMDSP further includes a shared data pool service configured to aggregate mobile data from one or more contributing sponsors. The SMDSP additionally includes an artificial intelligence (AI) server configured to evaluate a volume of mobile data to be granted to the sponsees from the shared data pool service to be offered by the one or more social entities. The evaluation is based on at least one of country of the sponsee, socio-economic background of the sponsee, and serving network operator of the sponsee.

According to various embodiments, a method for providing a social mobile data sharing platform (SMDSP) is disclosed. The method includes configuring a data sharing onboarding portal (DSOP) to onboard one or more social entities for offering mobile connectivity to one or more sponsees. The method further includes configuring a shared data pool service to aggregate mobile data from one or more contributing sponsors. The method additionally includes configuring an artificial intelligence (AI) server to evaluate a volume of mobile data to be granted to the sponsees from the shared data pool service to be offered by the one or more social entities. The evaluation is based on at least one of country of the sponsee, socio-economic background of the sponsee, and serving network operator of the sponsee.

Various other features and advantages will be made apparent from the following detailed description and the drawings.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only exemplary embodiments of the invention and are not, therefore, to be considered to be limiting its scope, the invention will be described and explained with additional specificity and detail through the use of the accompanying drawings, in which:

FIG. 1(a) depicts a diagram of cross-operator mobile data sharing plans available to at least IoT devices, mobile devices, tablets, and/or laptops according to an embodiment of the present invention;

FIG. 1(b) depicts a diagram of a cross-operator mobile data sharing plan during SIM-switch and/or roaming according to an embodiment of the present invention;

FIG. 2 depicts a diagram of enabling mobile connectivity by sponsor to sponsee according to an embodiment of the present invention;

FIG. 3(a) depicts a diagram of social sponsor onboarding on web/cloud platforms according to an embodiment of the present invention;

FIG. 3(b) depicts a diagram of an integration platform for mobile apps according to an embodiment of the present invention;

FIG. 3(c) depicts a diagram of qualifying subscriber selection and updating according to an embodiment of the present invention;

FIG. 3(d) depicts a diagram of mobile connectivity metering and analytics according to an embodiment of the present invention;

FIG. 4 depicts a diagram of data distribution channels and strategies by social sponsors according to an embodiment of the present invention;

FIG. 5 depicts a diagram of steps for offering mobile data connectivity according to an embodiment of the present invention;

FIG. 6 depicts a diagram of mobile data connectivity through matching programs according to an embodiment of the present invention;

FIG. 7(a) depicts a diagram of multi-carrier, cross platform, device independent data connectivity according to an embodiment of the present invention;

FIG. 7(b) depicts a diagram of accounts for data granted to qualifying subscribers according to an embodiment of the present invention;

FIG. 8 depicts a diagram of analytics of a sponsor and sponsee according to an embodiment of the present invention;

FIG. 9 depicts a diagram of sponsor/sponsee data sharing plans according to an embodiment of the present invention;

FIG. 10 depicts a diagram of a sponsor onboarding portal and payment system according to an embodiment of the present invention;

FIG. 11 depicts a diagram of a widget user interface and back-end system according to an embodiment of the present invention;

FIG. 12(a) depicts a diagram of plan activation by subscribers according to an embodiment of the present invention; and

FIG. 12(b) depicts a diagram of plan deactivation by subscribers according to an embodiment of the present invention.

### DETAILED DESCRIPTION OF THE INVENTION

According to various embodiments, generally disclosed herein is a Social Mobile Data Sharing Platform (SMDSP) that provides a universal collaboration unit to onboard trusted social entities such as but not limited to educational organizations, non-governmental organizations (NGOs), and entrepreneurial associations to support and offer mobile connectivity to those in need. The platform further creates an interface to allow sponsorship by which subscribers, corporations, mobile virtual network operators (MVNOs), and other operators can choose to sponsor mobile connectivity as well as donate mobile data to a common data pool. This can attract corporate initiatives and business participations to contribute towards corporate social responsibility (CSR) where they actively participate in matching programs for every act of donation made by their employees or customers. The data pool is driven by advanced analytics and algorithms to assign mobile connectivity to people under qualified metrics and provide them with data plans based on socio-economic background, country, and the offering operator network. The SMDSP can be integrated to any secured platform (e.g. banks, operator networks, social networks) through an authorized payment system. The service can work across the world irrespective of the operator network, country, or the type of device from where they undertake sponsorship or act as a beneficiary subscriber of mobile data.

Embodiments of this invention enable an easy integration mechanism to apps on diverse mobile platforms and websites hosted on the cloud. They work across multiple operator networks including 3G, 4G, 5G and femto cell. As a universal mobile social data sharing platform, they attract both individuals and large organizations to work unitedly by connecting people from remote corners of the world. The flexibility offered makes it remarkably easier to access for a majority of people by embedding a digital widget/plugin across different social networking, operator, or banking platforms with a backend authenticating agent and a payment gateway.

The social aspect motivates large to small corporations, brands, and sponsors to address some of the social challenges due to limited mobile reachability. Further, embodiments of the invention provide a basic platform for sponsors to start new initiates by providing mobile data connectivity to varying sections of the population and demographics based on any identifiable social cause. The data distribution model brings in different plans of providing connectivity or granting data to qualifying subscribers with prepaid and/or postpaid accounts. Further it provides capabilities to account volume of data transferred to different user-accounts with the accounting infrastructure being deployed either inside or outside the network operator.

Embodiments of the invention may include one or more of the following advantages:

Easy, transparent plan can be supported by MVNOs;

initiatives from corporates, organizations to participate in SCR;

integration unit can be embedded as a digital plugin or a digital widget to websites or as a widget to mobile apps;

provides an onboarding platform to onboard trusted entities to support social causes;

allows subscribers to select sponsees from an available list to allow and offers group plans for mobile connectivity and undertaking in data sharing activity;

allows for a motivating social cause where big organizations, brands, sponsors, NGOs, and individuals get a chance to contribute;

promotes social welfare both domestic and international;

connects people from remote parts of the world and provides them with opportunity to have access to better educational, healthcare, and/or government information;

provides a platform to people to provide mobile connectivity to anyone by keeping identities anonymous;

helps to take prompt relief actions under natural calamity and disaster;

enables better access to available services in case of emergency and life-threatening situations;

provides people with an opportunity to make informed decisions for matters governing day to day life by facilitating internet connectivity;

facilitates small scale business opportunities by connecting to a wider audience;

enables a universal platform where a user account is linked to a single payment gateway irrespective of the device being used;

allows for a system independent of the mobile/IOT device, laptop or desktop make, model, screen size and resolution;

allows for a system independent of the location and network operator when the connectivity being accessed is under the same user account;

leverages reward activities related to mobile data by providing mobile connectivity for social causes; and

can increase subscriber bases for MVNOs by providing people with mobile connectivity.

According to various embodiments, disclosed herein is an integrated client-server solution with any type of client (mobile/desktop/laptop/IOT devices) and back-end services deployed at cloud with the following functionalities to provide free mobile connectivity to users.

The system, referred to herein as a social mobile data sharing platform (SMDSP) can provide one or more of the following:

A digital widget, JavaScript (JS) plugin, or mobile app widget with capabilities to be embedded within secure web platforms hosted on the cloud such as but not limited to social networking sites, charity sites, network operator sites, banking sites, or mobile apps;

a back-end linked payment gateway responsible for credit transfer for social causes;

an on-boarding platform (or portal interface) that provides capabilities to on-board trusted entities including educational organizations, NGOs, social sponsors, entrepreneurial associations to engage in social cause of providing connectivity through mobile phones;

a reverse messaging gateway that provides communication between sponsor and sponsee;

a common connectivity platform with data pool service with enhanced artificial intelligence and analytics server for evaluating connectivity assignment criteria and data allocation strategies to qualifying subscribers and collecting metrics as to how data has been used for varying social causes; and

a back-end authentication agent, or back-end cloud system, that links to the payment gateway for any act of connectivity distribution or data contribution by an authorized agent such as but not limited to rewards systems, analytics systems, payment gateways, wallet system, and push notification systems.

The SMDSP system can be built as a standalone service as a website hosted on the cloud or as an integration unit to social good mobile apps or websites, operator apps or websites, social networking apps or websites. SMDSP system is equipped with a digital JavaScript plugin or widget that can be embedded in secured web platforms, websites and can be hosted from the cloud. The SMDSP system can also be equipped with an app widget and can be integrated with diverse mobile apps, websites or software development kits (SDKs).

The SMDSP system's credited data volume serviced from the common data pool account can be used by qualifying subscribers engaged social causes or subscribers who have been identified as in need by NGO's and institutions, or entrepreneurs for whom digital connectivity can make an impact. The credited mobile data may be used via a sponsored data platform that allows for a single app data to be sponsored, or for all data usage by the subscriber. Some nonlimiting examples of causes include: government websites and apps such as but not limited to tax filing, social identity record management, agriculture, and/or passport creation/renewal; disaster management and reporting websites/apps; educational websites/apps; charity/crowdfunding websites/apps; different kinds of finder apps such as but not limited to finding ATM booths, polling booths, and petrol pumps; blood donation websites/apps; emergency and healthcare websites/apps; finding and reporting missing children; socially impactful campaign creation and propagation; small-scale business scalability; and female entrepreneurship.

The SMDSP system can be accessed by users from mobile device, desktop, laptop or tablet, or single/multiple IOT devices like wearables or a personal emergency response system.

The SMDSP system communicates with an authentication agent at the back-end to authorize the sponsor to activate data transfer from the sponsor's account to the common connectivity platform and its associated data pool. The SMDSP system maintains a data bucket for each authentic sponsor and sponsee account to account volume of data transferred from each account to another account. The SMDSP service is equipped with a back-end authenticating agent that validates and authenticates each user account based on registered credentials. The authenticating agent is capable of validating user account irrespective of the device used to access mobile connectivity.

The SMDSP system can be supported by one or more MVNOs by providing simple, transparent, selective mobile connectivity plans available online/offline. Users can choose to sponsor mobile connectivity or transfer/donate their data amount to people in need without knowing the identity of the person to whom mobile connectivity is shared. Users can choose to include friends and family members in a pack as a group for single/multiple devices for each user. Users can spend more on the app, where a percentage of what they spend goes to the charity of their choice. Any data that the users do not use from their plan is also put in a common bucket and shared with an NGO by the MVNO. Connectivity plans can be offered to prepaid/postpaid subscribers. The SMDSP system allows selection of MVNO supported simple connectivity plans for crediting a part of their data to a universal data pool from which can offer plans to subscribers. Network operators can choose to provide the SMDSP system by enabling simple connectivity plans for social causes on the operator sites and apps. The SMDSP system can also include a gateway server that allows pass-through of all traffic (browsing data, reward grants) in case the MVNO does not account mobile connectivity and volume of data allocated from common connectivity platform and its associated data pool.

The SMDSP system may be linked with a payment gateway for each unique user/corporate/organization/social sponsor irrespective of the device the user uses to log in, and the payment gateway can use connectivity options or mobile data available from donations. The SMDSP service is equipped with a back-end payment gateway that is responsible for debit of mobile data from subscriber account who choose to be sponsors.

The SMDSP system provides easy means of mobile connectivity and data transfer cross-continent, cross-country, and cross-operator by allowing data distribution peer to peer or to authorized NGOs. The SMDSP system offers a platform for large corporations or businesses to engage in enterprise plans so that they get engaged in social welfare and charity acts by contributing equal amount as that of employee's contribution or purchases. The SMDSP system can include a matching contribution program for businesses to drive CSR where they contribute matching amount for every contribution made by their customers. The SMDSP system's operator supported connectivity plans manages and accounts for individuals, large corporates, and/or NGOs across geographically dispersed corners of the world with cross country operators. The SMDSP system offers an interface for large corporations, brands to tie up with MVNOs, and support users in need based on their usage of data through rewards and discounts.

The SMDSP system includes an analytics system to identify social improvement metrics based on one or more of the following nonlimiting examples: when, where, by whom, and for what social cause mobile connectivity has been used; statistics on purchase level and conversion rates for ads; statistics on literacy rate and other government identified social metrics; disaster management and recovery statistics; statistics on emergency casualties and health-care measurements; and statistics on agricultural performance and crop yield. The analytics system is responsible for working in coordination with a common connectivity platform and its associated data pool system equipped with smart algorithms to evaluate connectivity options and data allocation plans to qualifying subscribers based on country, socio-economic background, and operating network in question. The analytics system is responsible for working in coordination with the payment gateway for generating invoices for social sponsors on-boarded through the portal interface. The SMDSP includes an AI driven intelligent connectivity provider and data allocation server that calculates and evaluates the volume of data/connectivity to be granted to different qualifying subscribers from the common connectivity platform and shared data pool. The analytics system captures and accounts how each subscriber/corporate/brand has contributed data over time for significant social causes.

The SMDSP system includes a rewards server that retrieves usage information of each user from the analytics system and generates and grants appropriate data reward options. The analytics system further maintains statistics of recipient's data usage from reward grants, NGO initiatives, corporate and brand donations as well as contributions from individual sponsors.

The SMDSP system includes a data sharing onboarding platform (DSOP), which provides a platform for onboarding trusted entities who are social sponsors to offer mobile connectivity to qualifying subscribers. DSOP provides an interface for selecting subscriber sponsees and connectivity plans along with a volume of data to be offered to them. The Data Sharing Onboarding Portal (DSOP) provides a platform for onboarding brands, small and large enterprises, NGOs, trusted entities to register and drive challenging social causes like healthcare, emergency services, agriculture, education and government. The DSOP is provided with an interface to receive a URL to download and embed the plugin/widget within the sponsor's or enterprise's hosted web platform including the cloud and mobile apps.

The SMDSP system includes a notification service that pushes connectivity plans, data packs, data rewards to qualifying subscribers in need of mobile data. The SMDSP system has a messaging gateway to enable communication, acknowledgement between the sponsee and the sponsor.

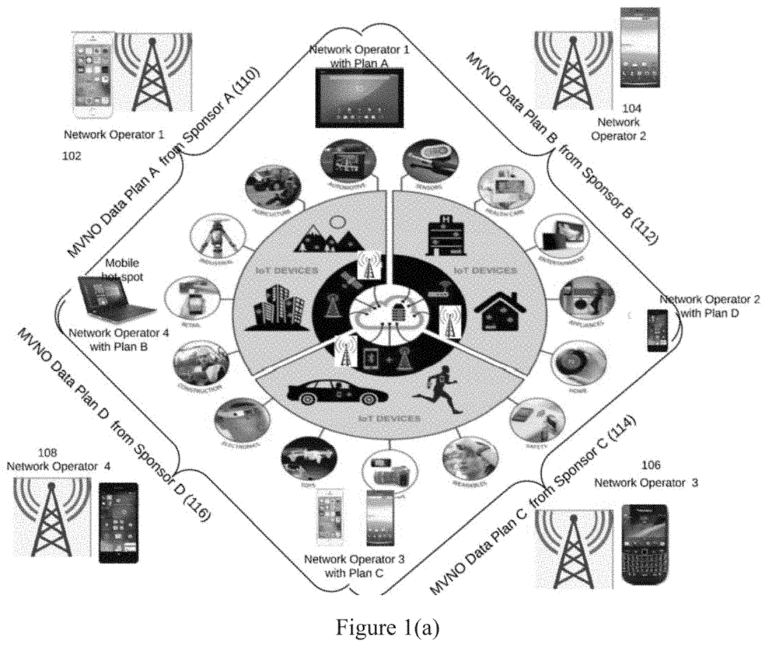

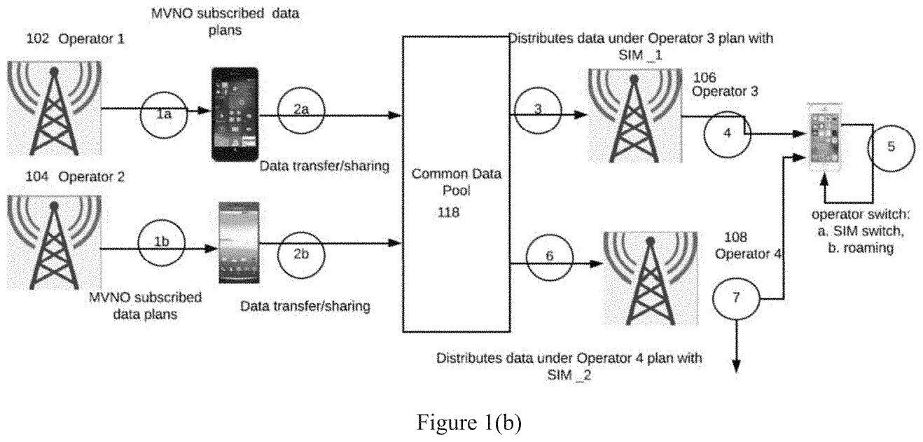

FIG. 1(a) depicts a diagram of cross-operator mobile data sharing plans available to at least IoT devices, mobile devices, tablets, and/or laptops as nonlimiting examples. A plurality of network operators 102, 104, 106, and 108 and a plurality of mobile data plans 110, 112, 114, and 116 are shown. While four operators and plans are illustrated, any number of network operators and data plans can be included. The cross-operation illustrates that any of the network operators 102, 104, 106, 108 can interact with any of the data plans 110, 112, 114, and 116 using any computing device.

FIG. 1(b) depicts a diagram of a cross-operator mobile data sharing plan during SIM-switch and/or roaming. Two operators 102, 104 are initially shown with their corresponding data plans 110, 112. It is to be noted the number of operators is for illustrative purposes only and not intended to be limiting. Data via operators 102, 104 is then transferred or shared to a common data pool 118. Data can then be distributed under operator 106 or operator 108 from the common data pool 118. This can occur during SIM switch or roaming as nonlimiting examples.

The sharing of data is enabled through the common data pool 118—where a user or an operator may deposit certain amount of credit, parts of the credit may then be redistributed to those who need. The mechanism may also be availed by a user, as a non-limiting example, by switching the SIM from operator 102 to operator —if the user happens to be roaming or in the coverage area of operator 106.

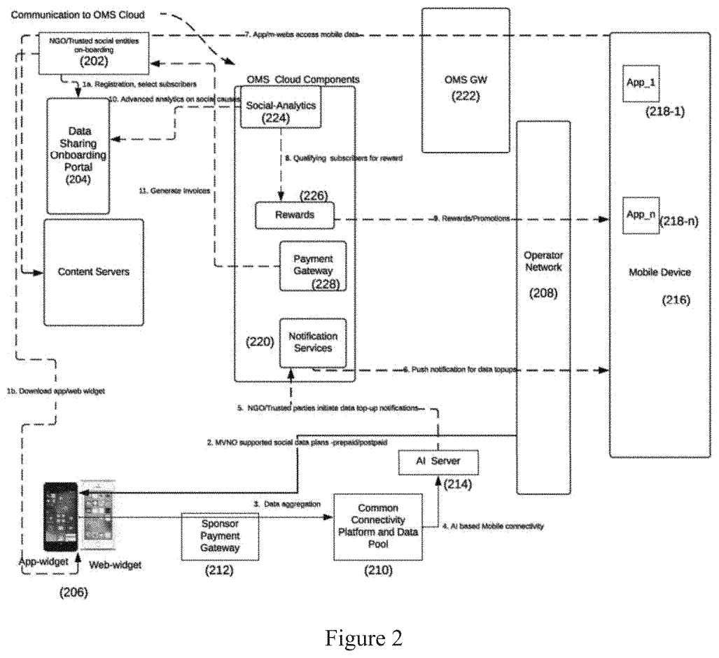

FIG. 2 depicts a diagram of enabling mobile connectivity by sponsor to sponsee. Trusted social entities 202 such as NGOs are onboarded via the DSOP 204. Here, at least registration and subscriber selection occur. The social entities 202 also download and/or start an app-widget or web-widget 206. An operator network 208, such as an MVNO, can support social data plans, which can be prepaid or postpaid. Data is then aggregated to a common connectivity platform and/or data pool 210, which can pass through a sponsor payment gateway 212. An AI server 214 is then used to initiate data top-ups to one or more mobile devices 216, where data is accessed via an application 218. The social entities 202 as well as the users of the mobile devices 216 are notified of the data top-up via a notification service 220 in an over the top mobile service (OMS) cloud platform. An OMS gateway 222 allows for communication between the social entities 202 and the mobile devices 216. The OMS cloud platform further includes social analytics 224 which communicates to a rewards platform 226 in order to send rewards or promotions to the mobile devices 216. The social analytics 224 also communicates with the DSOP 204 to send advanced analytics on social causes. The OMS cloud platform also includes a payment gateway 228 to generate invoices to send to the social entities 202.

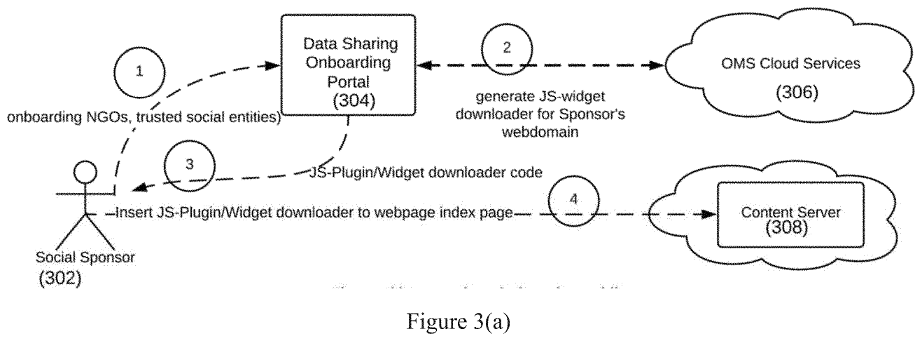

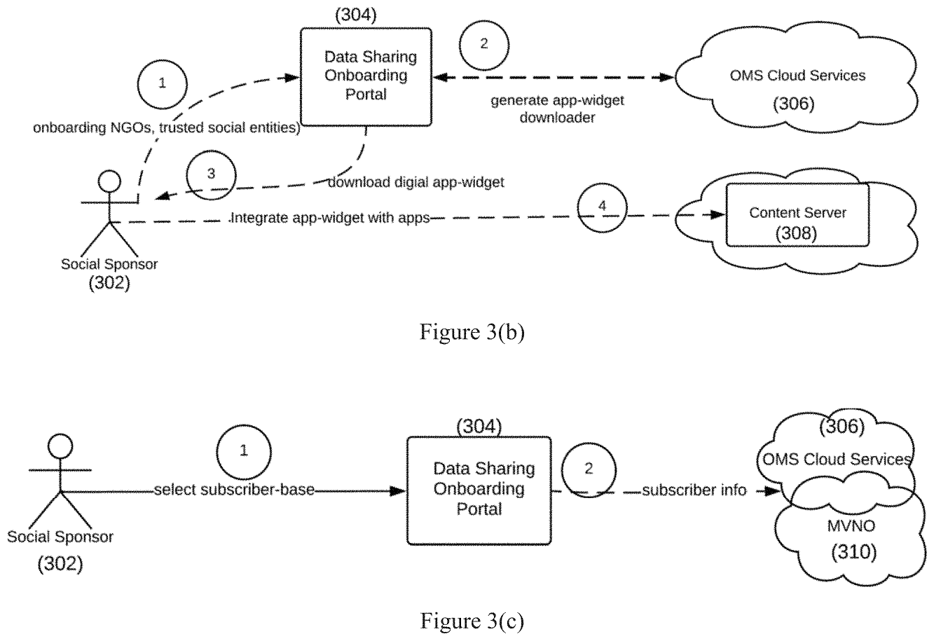

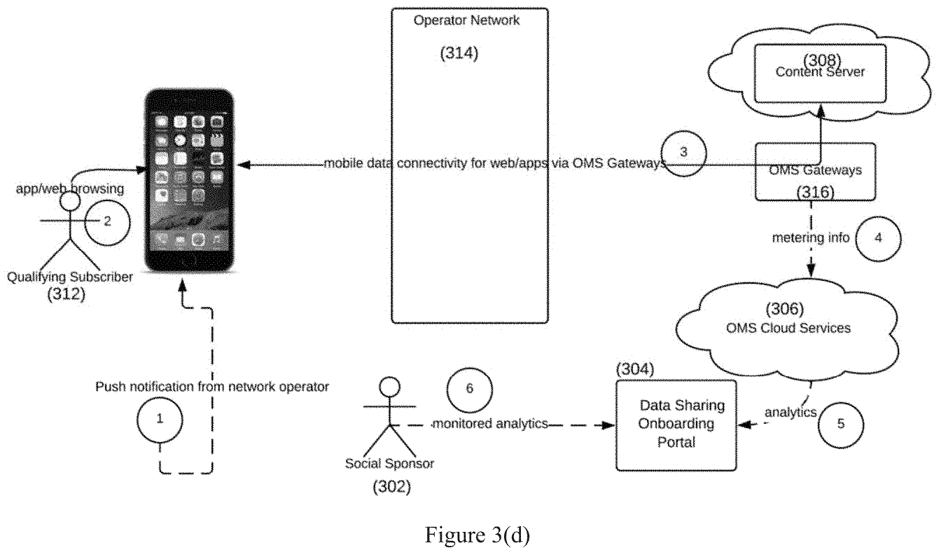

FIG. 3(a) depicts a diagram of social sponsor onboarding on web/cloud platforms. A social sponsor 302, such as an NGO or trusted social entity, is onboarded via a mobile connectivity and DSOP 304. An OMS cloud platform 306 communicates with the DSOP 304 to generate a JS-widget downloader for the web domain of the social sponsor 302. A downloader code is then sent to the social sponsor 302, which is then inserted into a webpage index page on a content server 308.

FIG. 3(b) depicts a diagram of an integration platform for mobile apps. The social sponsor 302 is onboarded via a mobile connectivity and DSOP 304. An OMS cloud platform 306 communicates with the DSOP 304 to generate an app-widget downloader. The social sponsor 302 then downloads the digital app-widget, which is then integrated with other apps on a content server 308.

FIG. 3(c) depicts a diagram of qualifying subscriber selection and updating. The social sponsor 302 selects a subscriber base which is communicated to the DSOP 304. Subscriber information is then communicated to the OMS cloud platform 306 as well as supporting MVNOs 308.

FIG. 3(d) depicts a diagram of mobile connectivity metering and analytics. A push notification is sent to a qualifying subscriber 312 in the app or web browser of their mobile device. A supporting operator network 314 allows for mobile data connectivity for web browsing or apps via an OMS gateway 316, which content derived from the content server 308. Metering information is then sent from the OMS gateway 316 to the OMS cloud platform 306, where analytics are communicated to the DSOP 304, to be monitored by the social sponsor 302.

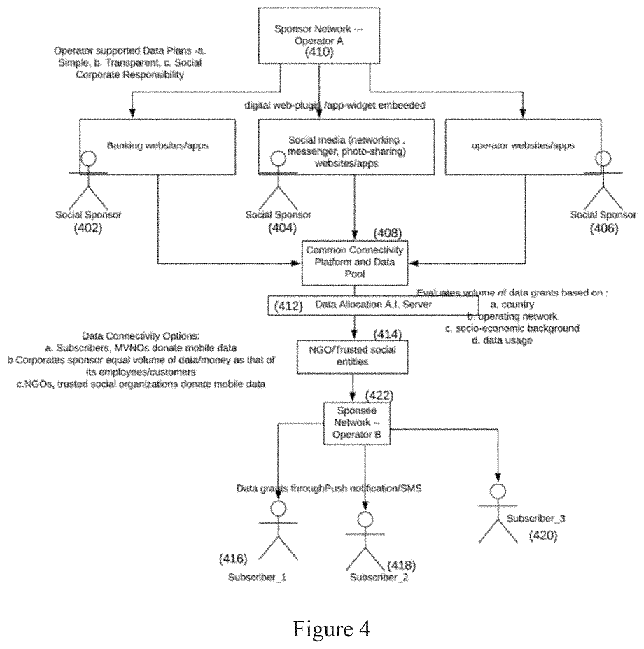

FIG. 4 depicts a diagram of data distribution channels and strategies by social sponsors. Any number of social sponsors, here shown as social sponsor 402 (banking), social sponsor 404 (social media), and social sponsor 406 (operator websites/apps), can transfer or share data to a common connectivity platform and data pool 408 via a supporting sponsor network operator 410 with a corresponding data plan. Some data connectivity options include but are not limited to sponsors donating mobile data, corporate sponsors matching employee sponsors in donating mobile data, and NGOs or social organizations donating mobile data. A data allocation AI server 412 evaluates data grants based on country, operating network, socio-economic background, and/or data usage as nonlimiting examples. An NGO or trusted social entity 414 can then transfer or share data to any number of sponsee subscribers, such as subscribers 416, 418, 420 by nonlimiting example via a supporting sponsee network operator 422.

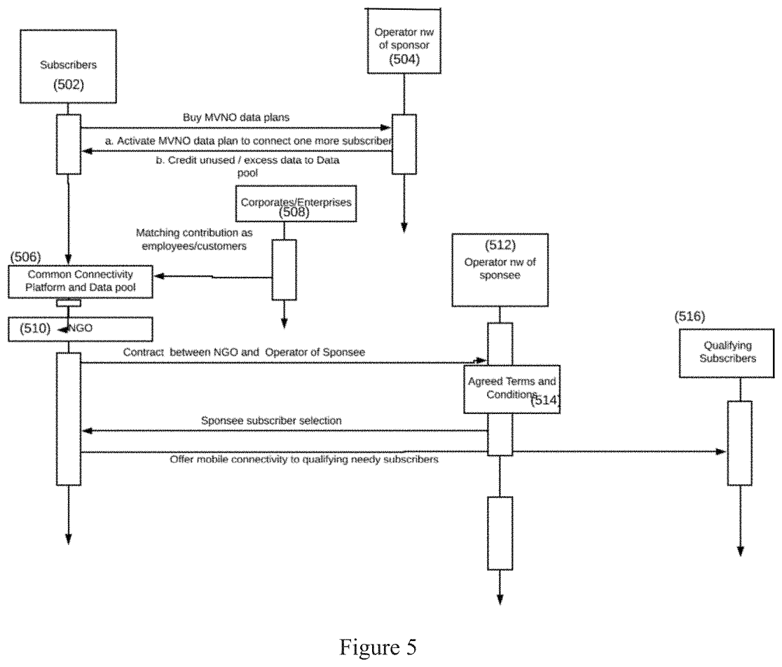

FIG. 5 depicts a diagram of steps for offering mobile data connectivity. Subscribers 502 buy MVNO data plans from an operator network 504 of a sponsor. The operator network 504 activates the MVNO data plan to connect one or more subscribers 502. Any unused or excess data is credited to a data pool 506. Corporations or enterprises 508 can also match contributions by their employees or customers, with the contributions being credited to the data pool 506 as well. An NGO or trusted social entity 510 contracts with an operator network 512 of a sponsee, with agreed terms and conditions 514, in order to offer mobile connectivity to qualify subscribers 516 in need.

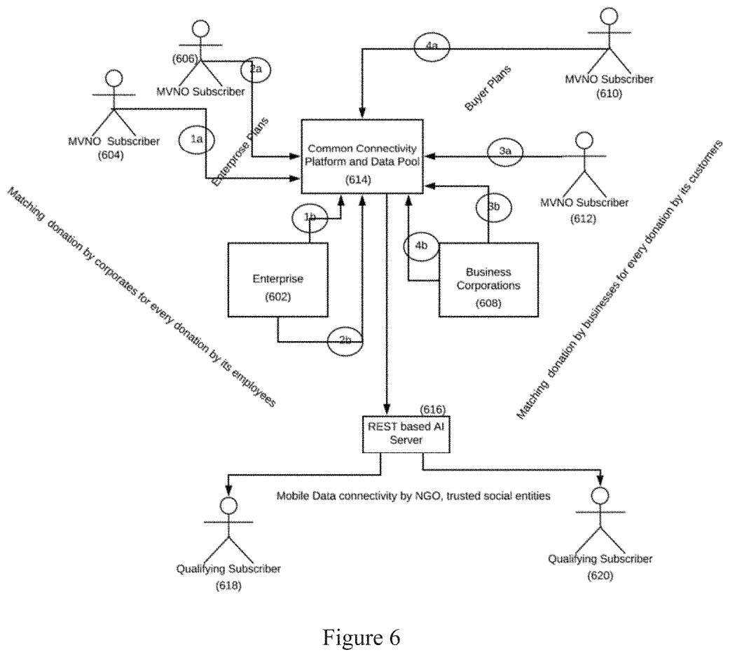

FIG. 6 depicts a diagram of mobile data connectivity through matching programs. Here, an enterprise 602 matches data donations from its employees, represented by MVNO subscribers 604, 606 and a business corporation 608 matches data donations from its customers, represented by MVNO subscribers 610, 612. All of this data is credited to a data pool 614, and a representational state transfer (REST) based AI server 616 allocates how mobile data is transferred via trusted social entities to qualifying subscribers, represented by subscribers 618, 620.

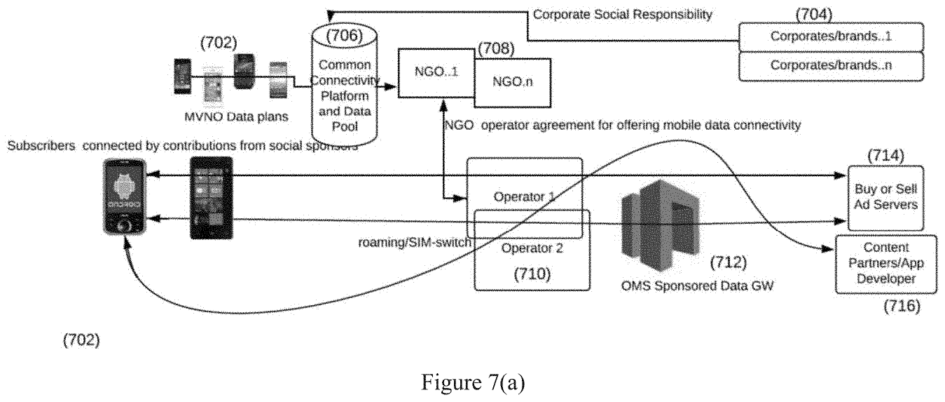

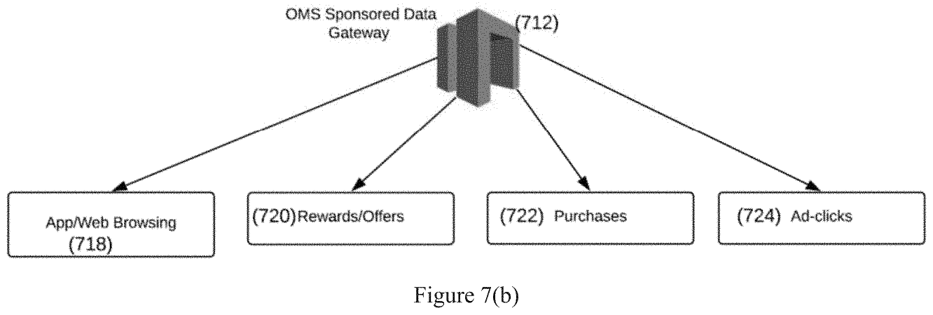

FIG. 7(a) depicts a diagram of multi-carrier, cross platform, device independent data connectivity. Data is collected from one or more MVNO data plans 702 and one or more corporate brands 704 into a data pool 706. That data is transferred to one or more NGOs or trusted social entities 708, which allocate the data to those in need via one or more operator networks 710. An OMS sponsored data gateway 712 can be included to allow for sponsored data from ad servers 714. The data allows for content and apps to be sent to those in need from content partners or app developers 716.

FIG. 7(b) depicts a diagram of accounts for data granted to qualifying subscribers. The account is based on the OMS sponsored data gateway 712, which includes modules for at least app/web browsing 718, rewards/offers 720, purchases 722, and ad-clicks 724.

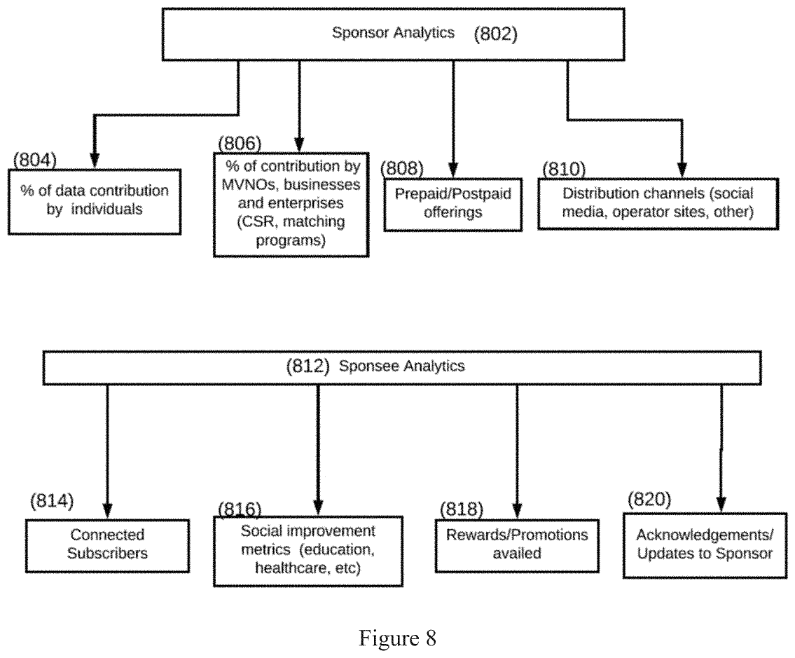

FIG. 8 depicts a diagram of an analytics system of a sponsor and sponsee. Sponsor analytics 802 can include but is not limited to percentage of data contribution by individuals 804, percentage of contribution by MVNOs, business, and/or enterprises 806, prepaid and/or postpaid offerings 808, and distribution channels 810. Sponsee analytics 812 can include but is not limited to connected subscribers 814, social improvement metrics 816, rewards/promotions availed 818, and acknowledgements and/or updates to a sponsor 820.

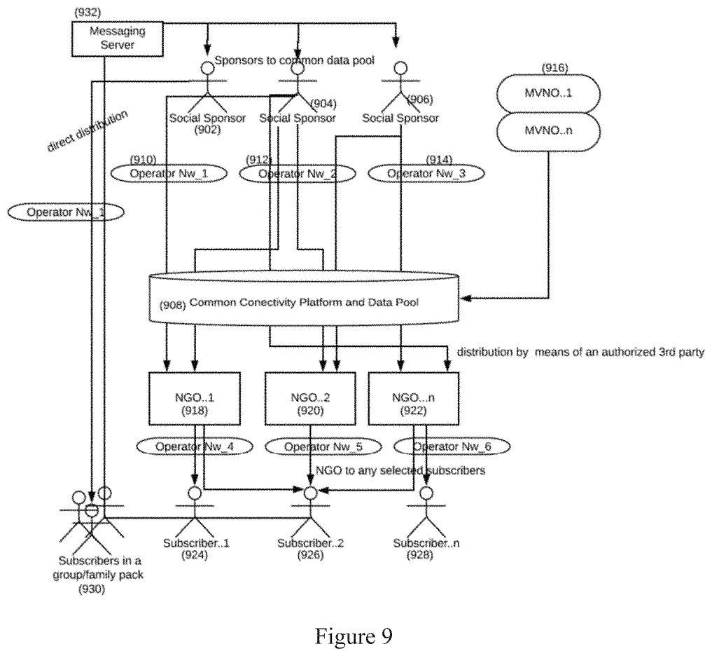

FIG. 9 depicts a diagram of sponsor/sponsee data sharing plans. A number of social sponsors, represented here by 902, 904, and 906 credit data to a common connectivity platform and data pool 908 via their respective operator networks, represented here by 910, 912, and 914. One or more MVNOs 916 can also credit to the data pool 908. A number of NGOs or trusted social entities, represented here by 918, 920, and 922 can then distribute the data to respective subscribers, represented here by 924, 926, and 928. Subscribers can be included in a group or family pack 930 as well. A messaging server 932 can be included for communication between sponsors 902, 904, and 906, and subscribers 924, 926, 928, and 930. Data is distributed via respective operator networks, here represented by 934, 936, and 938.

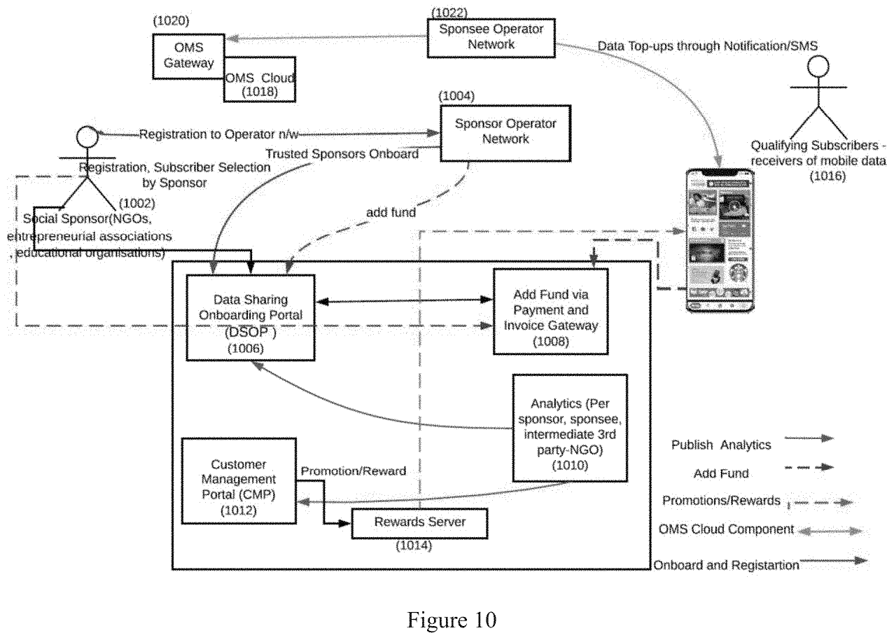

FIG. 10 depicts a diagram of a sponsor onboarding portal and payment system. Sponsors 1002 register to a sponsor operator network 1004, where the sponsors are onboard to a DSOP 1006. Funds are then added from the sponsor 1002 via a payment and invoice gateway 1008. Analytics 1010 are also communicated to the DSOP 1006 as well as a customer management portal 1012 in order to determine rewards allocation via a rewards server 1014. Qualifying subscribers 1016 will receive data top-ups from an OMS cloud platform 1018 that may include an OMS gateway 1020 via a sponsee operator network 1022.

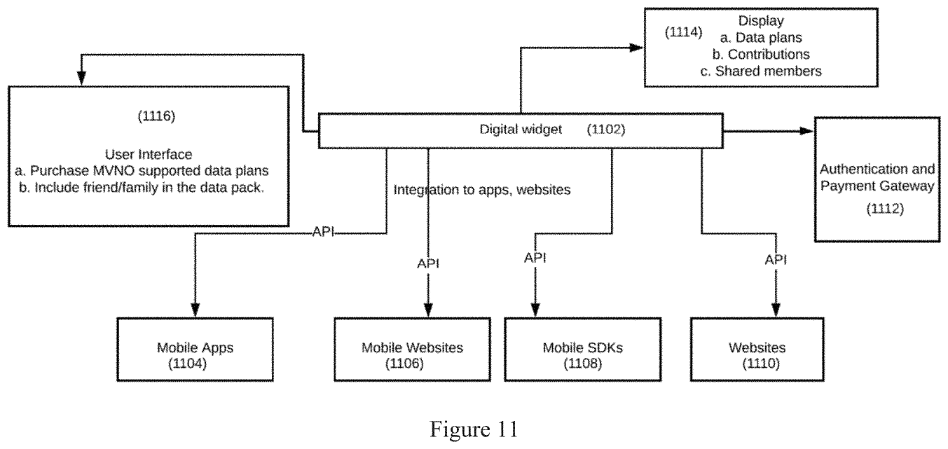

FIG. 11 depicts a diagram of a widget user interface and back-end system. The application program interface (API) for a digital widget 1102 can include but is not limited to mobile apps 1104, mobile websites 1106, mobile SDKs 1108, and websites 1110. The digital widget 1102 can access an authentication and payment gateway 1112. The digital widget 1102 includes a display 1114 to show data plans, contributions, and/or shared members as nonlimiting examples. The digital widget 1102 also includes a user interface 1116 to purchase MVNO supported data plans and/or include friends/family in the data pack as nonlimiting examples.

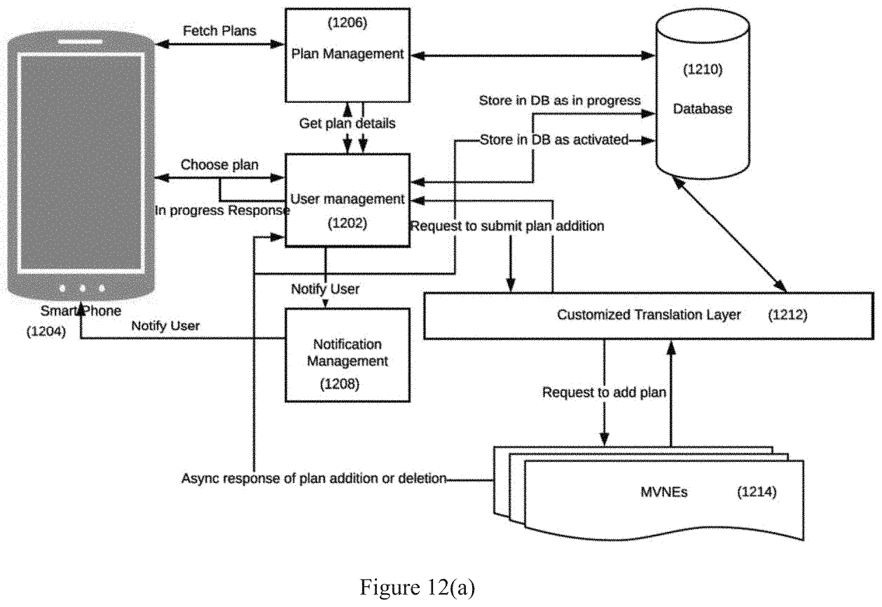

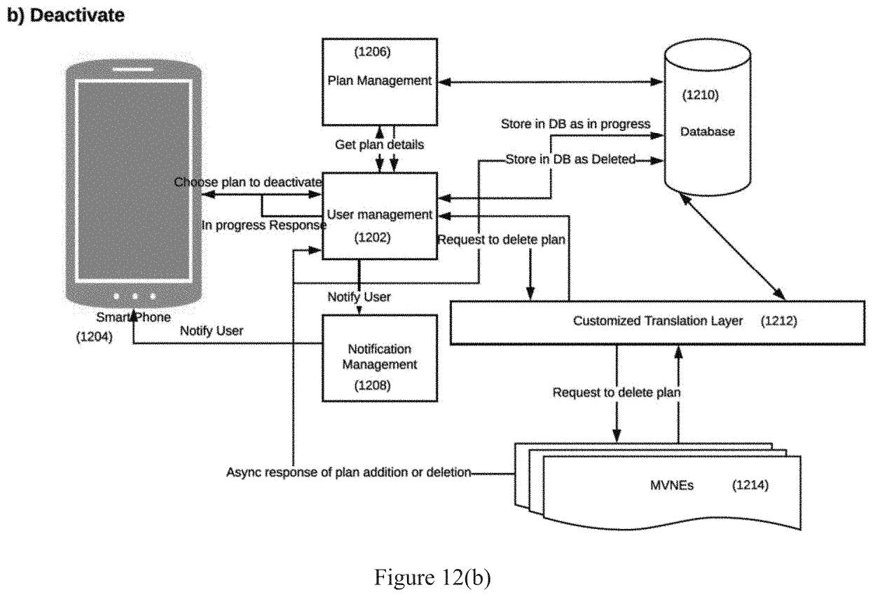

FIG. 12(a) depicts a diagram of plan activation by subscribers. This may occur in the cloud platform. Activation includes a user management module 1202, which allows for a user of a mobile device 1204 to choose a plan. Activation also includes a plan management module 1206 to exchange plan details with the user management module 1202 and fetch plans to/from the mobile device 1204. A notification management module 1208 notifies a user of the mobile device 1204 of any notifications from the user management module 1202. A database 1210 stores the plan as in progress or activated based on the user management module 1202 and plan management module 1206. A customized translation layer 1212 allows for requests to submit plan additions to the user management module 1202 as well as exchanging requests to add plans from MVNEs 1214, which communicate responses of plan addition to the user management module 1202.

FIG. 12(b) depicts a diagram of plan deactivation by subscribers according to an embodiment of the present invention. This may occur in the cloud platform. Deactivation involves the user management module 1202, which allows for a user of the mobile device 1204 deactivate their plan. Deactivation also involves a plan management module 1206 to exchange plan details with the user management module 1202. A notification management module 1208 notifies a user of the mobile device 1204 of any notifications from the user management module 1202. A database 1210 stores the plan as in progress or deleted based on the user management module 1202 and plan management module 1206. A customized translation layer 1212 allows for requests to delete plans to the user management module 1202 as well as exchanging requests to delete plans from MVNEs 1214, which communicate response of plan deletion to the user management module 1202.

It is understood that the above-described embodiments are only illustrative of the application of the principles of the present invention. The present invention may be embodied in other specific forms without departing from its spirit or essential characteristics. All changes that come within the meaning and range of equivalency of the claims are to be embraced within their scope. Thus, while the present invention has been fully described above with particularity and detail in connection with what is presently deemed to be the most practical and preferred embodiment of the invention, it will be apparent to those of ordinary skill in the art that numerous modifications may be made without departing from the principles and concepts of the invention as set forth in the claims.

What is claimed is:

1. A social mobile data sharing platform (SMDSP), comprising:
a data sharing onboarding portal (DSOP) configured to onboard one or more social entities for offering mobile connectivity to one or more sponsees;
a shared data pool service configured to aggregate mobile data from one or more contributing sponsors; and
an artificial intelligence (AI) server configured to evaluate a volume of mobile data to be granted to the sponsees from the shared data pool service to be offered by the one or more social entities, the evaluation being based on at least one of country of the sponsee, socio-economic background of the sponsee, and serving network operator of the sponsee.

2. The SMDSP of claim 1, wherein the social entities comprise at least one of non-governmental organizations (NGOs), content partners, and trusted social sponsors.

3. The SMDSP of claim 1, wherein the DSOP further comprises a user interface to register mobile connectivity sponsor details and social betterment causes.

4. The SMDSP of claim 1, further comprising a digital widget configured to be integrated with at least one of websites, apps, and software development kits.

5. The SMDSP of claim 4, wherein the digital widget is configured to communicate with an authentication and payment gateway for user authentication prior to sharing mobile data.

6. The SMDSP of claim 4, wherein the digital widget is configured to be downloaded from the DSOP portal.

7. The SMDSP of claim 4, wherein the digital widget comprises at least one of a mobile app widget and a JS plugin widget.

8. The SMDSP of claim 1, further comprising a mobile virtual network operator (MVNO) connectivity plan configured to support sharing of data to the sponsees.

9. The SMDSP of claim 1, wherein data is donated by one or more sponsors to be transferred to the shared data pool service.

10. The SMDSP of claim 9, wherein the one or more sponsors comprise at least one of individual users, MVNOs, and corporations.

11. The SMDSP of claim 1, wherein unused data from one or more sponsors is transferred to the shared data pool service.

12. The SMDSP of claim 1, further comprising an analytics server configured to maintain an accounting of social improvement metrics.

13. The SMDSP of claim 12, wherein the analytics server is further configured to coordinate with the AI server to evaluate connectivity options and data allocation plans for the sponsees.

14. A method for providing a social mobile data sharing platform (SMDSP), comprising:
configuring a data sharing onboarding portal (DSOP) to onboard one or more social entities for offering mobile connectivity to one or more sponsees;
configuring a shared data pool service to aggregate mobile data from one or more contributing sponsors; and
configuring an artificial intelligence (AI) server to evaluate a volume of mobile data to be granted to the sponsees from the shared data pool service to be offered by the one or more social entities, the evaluation being based on at least one of country of the sponsee, socio-economic background of the sponsee, and serving network operator of the sponsee.

15. The method of claim 14, further comprising configuring a digital widget to be integrated with at least one of websites, apps, and software development kits.

16. The method of claim 15, further comprising configuring the digital widget to communicate with an authentication and payment gateway for user authentication prior to sharing mobile data.

17. The method of claim 15, further comprising configuring the digital widget to be downloaded from the DSOP portal.

18. The method of claim 14, further comprising configuring a mobile virtual network operator (MVNO) connectivity plan to support sharing of data to the sponsees.

19. The method of claim 14, further comprising configuring an analytics server to maintain an accounting of social improvement metrics.

20. The method of claim 19, further comprising configuring the analytics server to coordinate with the AI server to evaluate connectivity options and data allocation plans for the sponsees.
